(19) United States
(12) Patent Application Publication
(10) Pub. No.: US 2008/0316105 A1
(43) Pub. Date: Dec. 25, 2008

(54) Method and Apparatus For Transmitter Locating Using a Single Receiver

(76) Inventors: Nak-Seon Seong, Daejon (KR); Choon-Sik Yim, Daejon (KR); Cheol-Sig Pyo, Daejon (KR); Jong-Suk Chae, Daejon (KR)

Correspondence Address: CANTOR COLBURN, LLP, 20 Church Street, 22nd Floor, Hartford, CT, 06103, US

(21) Appl. No.: 12/097,406

(22) PCT Filed: Dec. 12, 2006
(86) PCT No.: PCT/KR2006/005409

§ 371 Date: Jun. 13, 2008

(30) Foreign Application Priority Data
Dec. 15, 2005 (KR) 10-2005-0123652
Dec. 4, 2006 (KR) 10-2006-0121678

(51) Int. Cl. G01S 5/00

(52) U.S. Cl. 342/442

(57) ABSTRACT

Provided is a method and apparatus for locating a transmitter. The apparatus for locating a transmitter, including: an antenna having an antenna array for receiving first and second frequency signals transmitted from the transmitter and measuring an angle of the transmitter; a range of transmission (ROT) calculating unit for calculating the range of transmission of the transmitter based on phase difference between the first and second frequency signals; an angle of arrival (AoA) calculating unit for calculating the angle of the transmitter based on phase difference of common frequency signals received in the antenna; and a transmission location determining unit for determining the location of the transmitter based on the range of transmission and the angle of arrival of the transmitter.

### TECHNICAL FIELD

The present invention relates to a method and apparatus for locating a transmitter; and, more particularly, to a method and apparatus for locating a transmitter in a single receiver.

### BACKGROUND ART

Triangulation is generally used to receive a transmission signal of a transmitter in at least three receivers and locate a transmitter based on measured time of arrival (ToA), time difference of arrival (TDoA), received signal strength indication (RSSI), and angle of arrival (AoA).

As shown in FIG. 1, in the triangulation, at least three radio stations 111, 112 and 113 should receive a signal of a transmitter 100 and measure a range or an angle of the transmitter. Also, a single location calculating server 140 is required to calculate a location 130 of the transmitter by integrating the measured information.

At least three receivers 111, 112 and 113 are required to locate the transmitter 100 according to the triangulation. Accordingly, a problem generated in a single receiver may affect an entire location measuring system. Also, when a system is modified or additionally disposed to control or extend a location determination region, there is a difficulty in overall control of the location determination system due to characteristics of the system where each of the receivers 111, 112 and 113 cooperates. The difficulty becomes a large obstacle when the current location determination system is actively applied.

In particular, when the TDOA method is adopted in the triangulation, time synchronization among the receivers 111, 112 and 113 is necessary. However, there is a problem that the time synchronization among the receivers 111, 112 and 113 imposes a heavy burden on software and hardware of the system.

Therefore, in a location determining method by the triangulation using at least three conventional receivers, system configuration is very complicated in connection of a communication link for collecting time synchronization among the receivers and location determination information from each receiver. Also, there is a problem that it is difficult to control and extend the system due to inflexibility of the system.

### DISCLOSURE

### Technical Problem

It is, therefore, an object of the present invention to provide a method and apparatus for locating a transmitter in a single receiver by receiving at least two orthogonal frequencies from a transmitter, measuring a range of transmission (ROT) of the transmitter and measuring an angle of the transmitter based on array of at least two antennas.

It is another object of the present invention to provide a method and apparatus for exactly locating the transmitter by solving an ambiguity problem of the range and add an angle of the transmitter based on time difference between radio signals transmitted through an array antenna.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

### Technical Solution

In accordance with one aspect of the present invention, there is provided an apparatus for locating a transmitter, including: an antenna having an antenna array for receiving first and second frequency signals transmitted from the transmitter and measuring an angle of the transmitter; a range of transmission (ROT) calculating unit for calculating the range of transmission of the transmitter based on phase difference between the first and second frequency signals; an angle of arrival (AoA) calculating unit for calculating the angle of the transmitter based on phase difference of common frequency signals received in the antenna; and a transmission location determining unit for determining the location of the transmitter based on the range of transmission and the angle of arrival of the transmitter. The first and second frequency signals have an orthogonal frequency. The ROT calculating unit extracts a propagation time based on the phase difference of the first and second frequency signals and calculates the range of transmission of the transmitter based on the extracted propagation time.

Also, the apparatus further includes a time difference of arrival (TDOA) calculating unit for calculating the approximate location of the transmitter based on the time difference of arrival between common frequency signals received in the antenna. The transmission location determining unit determines the location of the transmitter by removing ambiguity of the range of transmission of the transmitter due to phase difference between the orthogonal frequency signals based on the approximate location, which is calculated in the TDOA calculating unit, and ambiguity of the angle of the transmitter due to phase difference between common frequency signals.

In accordance with another aspect of the present invention, there is provided a method for locating a transmitter, including the steps of: a) receiving first and second frequency signals transmitted from the transmitter through an antenna having an antenna array for measuring an angle of arrival of the transmitter; b) calculating an ROT based on phase difference of the first and second frequency signals; c) calculating the angle of the transmitter based on phase difference of the received common frequency signal; and d) determining a location of the transmitter based on the range of transmission of the transmitter and the angle of the transmitter. The first and second frequency signals have an orthogonal frequency. The method further includes the step of: e) calculating an approximate location of the transmitter based on the time difference of arrival between received common frequency signals. In the steps d), the location of the transmitter is determined by removing ambiguity of the range of transmission of the transmitter based on the approximate location and removing ambiguity of the angle of the transmitter based on the approximate location, which is calculated in the step e).

### ADVANTAGEOUS EFFECTS

The present invention can locate a transmitter in a single receiver by receiving at least two orthogonal frequencies from the transmitter, measuring a range of transmission (ROT) of the transmitter and measuring an angle of the transmitter based on array of at least two antennas.

The present invention can calculate an exact location of the transmitter not by using conventional triangulation based on a plurality of receivers but by using a single receiver. Therefore, the present invention can solve an inflexibility problem of a location determination system and provide flexibility to the system by setting up and extending the system.

Also, the present invention can exactly locate the transmitter by removing ambiguity of the range and the angle of the transmitter based on the time difference of arrival of common frequency radio signals transmitted through an array antenna.

### DESCRIPTION OF DRAWINGS

The above and other objects and features of the present invention will become apparent from the following description of the preferred embodiments given in conjunction with the accompanying drawings, in which:

FIG. 1 shows a conventional locating method based on triangulation;

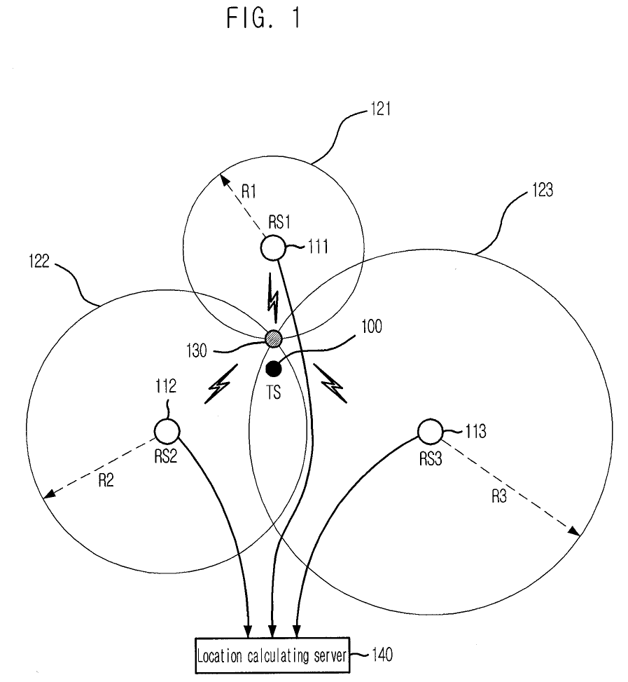

FIG. 2 is a block diagram showing an apparatus for locating a transmitter in accordance with an embodiment of the present invention;

FIG. 3 is a flowchart describing an operation of the transmitter locating apparatus of FIG. 2; and

FIG. 4 shows a location determining method of the transmitter according to an embodiment of the present invention.

### DESCRIPTION OF CODES ON MAIN PARTS IN DRAWINGS

201-203: multiple antennas
230: Phase difference detecting unit between orthogonal frequencies
240 Phase difference detecting unit between common frequencies
250 Time difference detecting unit between common frequencies
260 ROT calculating unit
270 AOA calculating unit
280 TDOA calculating unit
290 Transmitter location determining unit

### BEST MODE FOR THE INVENTION

Other objects and advantages of the present invention will become apparent from the following description of the embodiments with reference to the accompanying drawings. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

The present invention calculates a range of transmission (ROT) of a transmitter based on the phase difference between orthogonal frequency signals transmitted from the transmitter and calculates an angle of arrival (AoA) of the transmitter based on the phase difference between common frequency signals transmitted from the transmitter to an array antenna. Also, the present invention can determine a location of the transmitter in a single receiver by determining a location of a radio transmitter according to the range of transmission of the transmitter and the angle of the transmitter.

To be specific, the present invention measures the range of transmission of the transmitter by receiving at least two orthogonal frequency signals transmitted from the transmitter by using multiple antennas more than two and locates the transmitter by measuring the angle of arrival of the transmitter by using at least two array antennas. Also, the present invention can estimate an exact location of the transmitter by removing ambiguity of the range of transmission and the angle of arrival based on time difference between common frequency radio signals transmitted from at least two array antennas.

The present invention can locate a radio transmitter by receiving at least two different frequencies, which are not orthogonal, and remove ambiguity. The orthogonal frequency may be used to minimize interference of the signals that the transmitter locating apparatus receives.

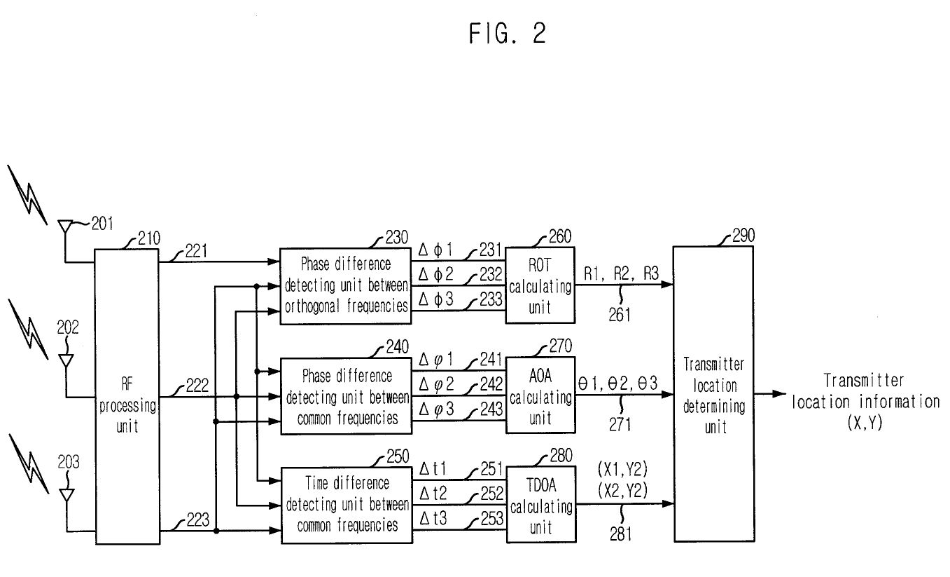

FIG. 2 is a block diagram showing an apparatus for locating the transmitter by receiving three orthogonal frequency signals transmitted from the transmitter through three antennas in accordance with an embodiment of the present invention.

The transmitter locating apparatus according to the present invention includes at least two antennas 201, 202 and 203, a Radio Frequency (RF) processing unit 210, a phase difference detecting unit between orthogonal frequencies 230, a phase difference detecting unit between common frequencies 240, a time difference detecting unit between common frequencies 250, an ROT calculating unit 260, an angle of arrival (AoA) calculating unit 270, a time difference of arrival (TDOA) calculating unit 280 and a transmitter location determining unit 290.

The multiple antennas 201, 202 and 203 receive the orthogonal frequency signal transmitted from the transmitter. For example, the first antenna 201 receives a signal having orthogonal frequencies f1 and f2 and the second antenna 202 receives a signal having orthogonal frequencies f2 and f3. The third antenna 203 receives a signal having orthogonal frequencies f3 and f1. Also, antenna devices receiving a common frequency signal have an array for measuring the angle of arrival of the transmitter. The multiple antennas 201 to 203 may have diverse formats of an omni antenna, a sector antenna, and a polarization antenna.

The RF processing unit 210 performs an RF signal process such as signal amplification and signal compensation on the orthogonal frequency signal received in the multiple antennas 201 to 203. Subsequently, the RF processing unit 210 transmits the orthogonal frequency signal to the phase difference detecting unit between orthogonal frequencies 230, the phase difference detecting unit between common frequencies 240, the time difference detecting unit between common frequencies 250. RF end output can be realized as intermediate frequency (IF) output.

The phase difference detecting unit between orthogonal frequencies 230 detects phase differences Δφ1, Δφ2, and Δφ3 of the orthogonal frequency signal on which the RF signal process is performed. Herein, Δφn where n=1, 2, 3 shows the phase difference of two orthogonal frequency signals received in n^{th} antenna.

The phase difference detecting unit between common frequencies 240 detects phase differences Δψ1, Δψ2 and Δψ3 of the common frequency signal on which the RF signal process is performed. Herein, Δψn where n=1, 2, 3 shows the phase difference of the common frequency signal received in two antennas, i.e., the first and second antennas, the second and third antennas, or the third and first antennas.

The time difference detecting unit between common frequencies 250 detects time differences Δt1, Δt2 and Δt3 of the common frequency signal on which the RF signal process is performed. Herein, Δtn where n=1, 2, 3 shows the phase difference of the common frequency signal received in two antennas, i.e., the first and second antennas, the second and third antennas, or the third and first antennas.

The ROT calculating unit 260 calculates ROTs R1, R2, and R3 based on the phase differences Δφ1, Δφ2, and Δφ3 of the orthogonal frequency signal detected in the phase difference detecting unit between orthogonal frequencies 230. That is, the ROT calculating unit 260 extracts a propagation time from the detected phase difference according to Equation 1 below and calculates the ROTs R1, R2, and R3 according to the extracted propagation time and Equation 2.

Phase difference of two orthogonal frequencies 1 and 2=(Frequency 1−Frequency 2)*Propagation time of Radio wave. Equation 1

Distance=Propagation time*Propagation speed (C=3*10⁸ [m/sec]) Equation 2

The AoA calculating unit 270 calculates AoAs θ1, θ2, and θ3 of the transmitter based on the phase differences Δψ1, Δψ2 and Δψ3 of the common frequency signal detected in the phase difference detecting unit between common frequencies 240. That is, the AoA calculating unit 270 calculates the angle of arrival of the transmitter based on three antenna arrays.

The TDOA calculating unit 280 calculates approximate locations (X1,Y1) and (X2,Y2) of the transmitter according to the TDOA method based on the time differences Δt1, Δt2 and Δt3 of the common frequency signal detected in the time difference detecting unit between common frequencies 250.

The transmitter location determining unit 290 receives the ROT information R1, R2 and R3, the AoA information θ1, θ2 and θ3, and approximate location information (X1,Y1) and (X2,Y2) of the transmitter from the ROT calculating unit 260, the AoA calculating unit 270 and the TDOA calculating unit 280. Subsequently, the transmitter location determining unit 290 exactly calculates an ROT (X,Y). To be specific, the transmitter location determining unit 290 determines an exact ROT R by removing ambiguity of an ROT 261 calculated in the ROT calculating unit 260 based on approximate location information 281 of the TDOA, removes ambiguity of an AoA 271 calculated in the AoA calculating unit 270 based on the approximate location information 281 by the TDO, and determines the exact AoA θ, thereby calculating the ROT (X,Y) of the exact transmitter.

Meanwhile, the transmitter location determining unit 290 receives AoA information through TDOA from the TDOA calculating unit 280, thereby removing ambiguity of the ROT 261.

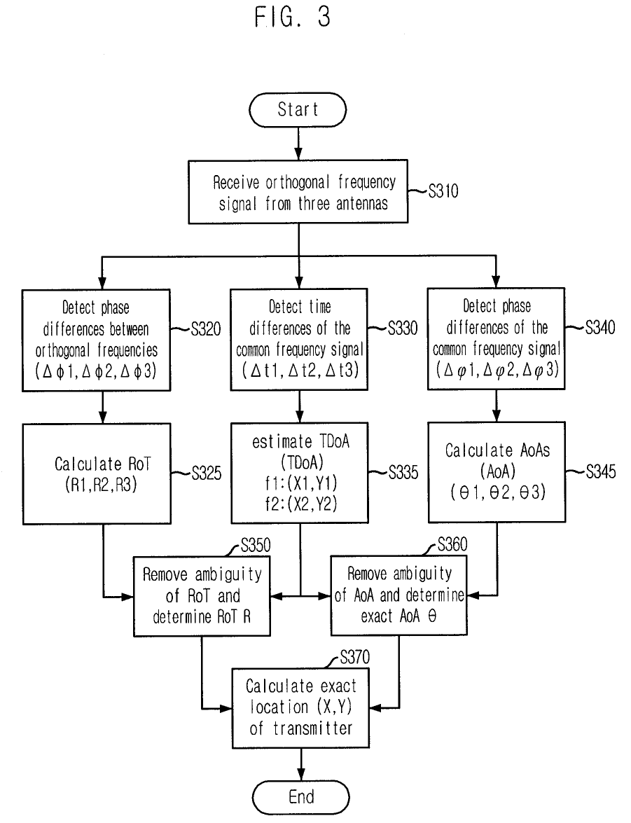

FIG. 3 is a flowchart describing an operation of the transmitter locating apparatus of FIG. 2.

The transmitter locating apparatus receives an orthogonal frequency signal transmitted from the transmitter based on three antennas 201, 202 and 203 at step S310.

The time difference detecting unit between common frequencies 250 detects time differences Δt1, Δt2 and Δt3 of the common frequency signal received in the multiple antennas 201 to 203 at step S330. Subsequently, the TDOA calculating unit 280 estimates approximate locations (X1,Y1) and (X2,Y2) of the transmitter according to the TDOA method based on the time differences Δt1, Δt2 and Δt3 of the common frequency signal detected in the time difference detecting unit between common frequencies 250 at step S335.

The phase difference detecting unit between orthogonal frequencies 230 detects the phase differences Δφ1, Δφ2 and Δφ3 of the orthogonal frequency signal received in the multiple antennas 201 to 203 at step S320. Subsequently, the ROT calculating unit 260 calculates ROTs R1, R2 and R3 based on the phase differences Δφ1, Δφ2 and Δφ3 of the orthogonal frequency signal detected in the phase difference detecting unit between orthogonal frequencies 230 at step S325.

When the phase difference between orthogonal frequencies is used, the same phase may be generated is a plurality of time durations.

That is, when the range of transmission is calculated based on Equations 1 and 2, all times of arrival whose phase increases as much as 360° generate ambiguity of the range of transmission of the transmitter.

Therefore, the transmitter location determining unit 290 removes the ambiguity of the range of transmission of the transmitter based on the approximate location information estimated by the TDOA at the step S335 and determines an exact ROT R at step S350. That is, the transmitter location determining unit 290 determines a radius of which circle among circles drawn by the range of transmission of the transmitter calculated at the step S325 corresponds to an actual range of transmission of the transmitter. Meanwhile, the transmitter location determining unit 290 receives the AoA information calculated in the TDOA calculating unit 280 through the TDOA and determines the exact ROT R.

The phase difference detecting unit between common frequencies 240 detects phase differences Δψ1, Δψ2 and Δψ3 of the common frequency signal received in the multiple antennas 201 to 203 at step S340. Subsequently, the AOA calculating unit 270 calculates AoAs θ1, θ2 and θ3 of the transmitter based on the phase differences Δψ1, Δψ2 and Δψ3 of the common frequency signal detected in the phase difference detecting unit between common frequencies 240 at step S345. That is, the AoA calculating unit 270 calculates the angle of arrival of the transmitter by using three antenna arrays.

When the phase difference between common frequencies is used, the phase of the array antenna is used and it causes generation of a plurality of detection angles. Therefore, the transmitter location determining unit 290 removes ambiguity of the angle of arrival based on the approximate location information estimated by the TDOA at the step S335 and determines an exact AoA θ at step S360.

At step S370, the transmitter location determining unit 290 calculates an exact location (X,Y) of the transmitter, which is an intersecting point of the circle drawn by the ROT R determined at the step S350 and the AoA θ determined at step S360.

In FIGS. 2 and 3, the case that the transmitter is located through three antennas is described. However, it is obvious to those skilled in the art that the transmitter can be located by receiving two orthogonal frequency signals transmitted from the transmitter through at least two antennas. In this case, the transmitter locating apparatus estimates two ROTs by detecting two orthogonal frequency phase differences and estimates two AoAs by detecting two common frequency phase differences. Also, the transmitter locating apparatus estimates an approximate location by the TDOA by detecting the time difference between two common frequencies and removes the ambiguity of the range of transmission of the transmitter and the angle of arrival based on the estimated approximate location.

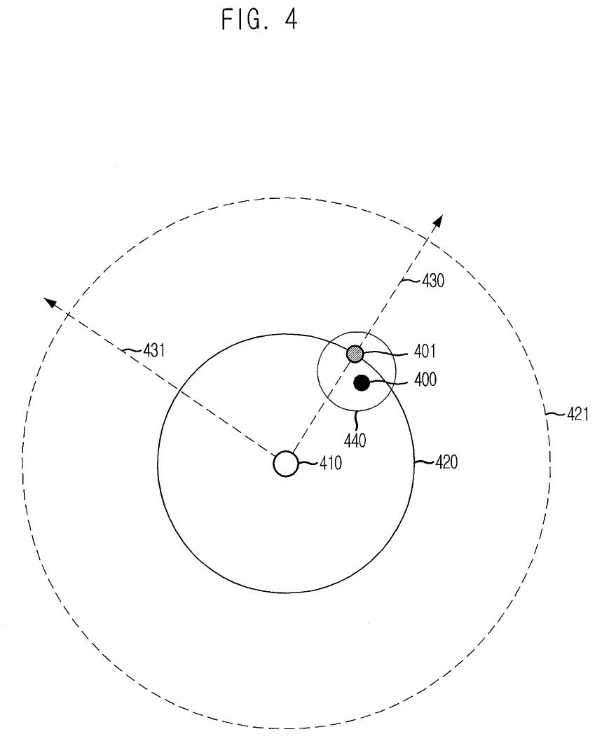

FIG. 4 shows a location determining method of the transmitter based on two antennas and the orthogonal frequency according to an embodiment of the present invention.

FIG. 4 shows two ROT circles 420 and 421 having two different ROTs as a radius due to the phase ambiguity generated by detecting the phase difference of the orthogonal frequency signal.

Two AoAs 430 and 431 appears due to the ambiguity of the phase generated by detecting the phase difference of the common frequency signal.

Therefore, the transmitter locating apparatus detects a time difference of a common frequency signal, calculates an approximate location 440 according to the TDOA method based on the detected difference information of the common frequency signal, removes the ambiguity of the range of transmission and the angle of arrival based on the calculated approximate location 440, and determines a final single ROT circle 420 and a final single AoA 430. Subsequently, the transmitter locating apparatus determines an intersecting point of the determined ROT circle 420 and the AoA 430 as a final location 401 of the transmitter 400.

While the present invention has been described with respect to certain preferred embodiments, it will be apparent to those skilled in the art that various changes and modifications may be made without departing from the scope of the invention as defined in the following claims.

### INDUSTRIAL APPLICABILITY

The present invention is used to a transmitter locating apparatus and a location determination system.

1. An apparatus for locating a transmitter, comprising:
an antenna having an antenna array for receiving first and second frequency signals transmitted from the transmitter and measuring an angle of the transmitter;
a range of transmission (ROT) calculating unit for calculating the range of transmission of the transmitter based on phase difference between the first and second frequency signals;
an angle of arrival (AoA) calculating unit for calculating the angle of the transmitter based on phase difference of common frequency signals received in the antenna; and
a transmission location determining unit for determining the location of the transmitter based on the range of transmission and the angle of arrival of the transmitter.

2. The apparatus as recited in claim 1, wherein the first and second frequency signals have an orthogonal frequency.

3. The apparatus as recited in claim 1, wherein the ROT calculating unit extracts a propagation time based on the phase difference of the first and second frequency signals and calculates the range of transmission of the transmitter based on the extracted propagation time.

4. The apparatus as recited in claim 2, further comprising:
a time difference of arrival (TDOA) calculating unit for calculating the approximate location of the transmitter based on the time difference of arrival between common frequency signals received in the antenna.

5. The apparatus as recited in claim 4, wherein the ROT calculating unit calculates the range of transmission of the transmitter based on phase difference between at least two orthogonal frequency signals and the AoA calculating unit calculates the angle of the transmitter based on phase difference between at least two common frequency signals.

6. The apparatus as recited in claim 4, wherein the transmission location determining unit determines the location of the transmitter by removing ambiguity of the range of transmission of the transmitter due to phase difference between the orthogonal frequency signals based on the approximate location and ambiguity of the angle of the transmitter due to phase difference between common frequency signals.

7. The apparatus as recited in claim 4, wherein the transmission location determining unit determines the location of the transmitter by removing the ambiguity of the range of transmission of the transmitter due to the phase difference between orthogonal frequency signals based on the AoA information according to the TDoA and by removing the ambiguity of the angle of the transmitter due to the phase difference between common frequency signals based on the approximate location.

8. A method for locating a transmitter, comprising the steps of:
a) receiving first and second frequency signals transmitted from the transmitter through an antenna having an antenna array for measuring an angle of arrival (AoA) of the transmitter;
b) calculating a range of transmission (ROT) of the transmitter based on phase difference of the first and second frequency signals;
c) calculating the angle of the transmitter based on phase difference of the received common frequency signal; and
d) determining a location of the transmitter based on the range of transmission of the transmitter and the angle of the transmitter.

9. The method as recited in claim 8, wherein the first and second frequency signals have an orthogonal frequency.

10. The method as recited in claim 8, wherein the step b) includes the steps of:
b1) extracting a propagation time based on phase difference of the first and second frequency signals; and
b2) calculating the range of transmission of the transmitter based on the extracted propagation time.

11. The method as recited in claim 9, further comprising the step of:
e) calculating an approximate location of the transmitter based on the time difference of arrival between received common frequency signals.

12. The method as recited in claim 11, wherein in the step b), the range of transmission of the transmitter is calculated based on phase difference between at least two orthogonal frequency signals and the angle of the transmitter is calculated based on phase difference between at least two common frequency signals.

13. The method as recited in claim 11, wherein the steps d) includes the steps of:
d1) removing ambiguity of the range of transmission of the transmitter due to the phase difference between the orthogonal frequency signals based on the approximate location; and
d2) removing ambiguity of the angle of the transmitter due to the phase difference between common frequency signals based on the approximate location.

14. The method as recited in claim 11, wherein the steps d) includes the steps of:
d3) removing ambiguity of the range of transmission of the transmitter due to phase difference between orthogonal frequency signals based on the AoA information according to the time difference of arrival (TDoA); and
d4) removing ambiguity of the angle of the transmitter due to phase difference between common frequency signals based on the approximate location.

15. The apparatus as recited in claim 2, wherein the ROT calculating unit extracts a propagation time based on the phase difference of the first and second frequency signals and calculates the range of transmission of the transmitter based on the extracted propagation time.

16. The apparatus as recited in claim 5, wherein the transmission location determining unit determines the location of the transmitter by removing ambiguity of the range of transmission of the transmitter due to phase difference between the orthogonal frequency signals based on the approximate location and ambiguity of the angle of the transmitter due to phase difference between common frequency signals.

17. The apparatus as recited in claim 5, wherein the transmission location determining unit determines the location of the transmitter by removing the ambiguity of the range of transmission of the transmitter due to the phase difference between orthogonal frequency signals based on the AoA information according to the TDoA and by removing the ambiguity of the angle of the transmitter due to the phase difference between common frequency signals based on the approximate location.

18. The method as recited in claim 9, wherein the step b) includes the steps of:
b1) extracting a propagation time based on phase difference of the first and second frequency signals; and
b2) calculating the range of transmission of the transmitter based on the extracted propagation time.

19. The method as recited in claim 12, wherein the steps d) includes the steps of:
d1) removing ambiguity of the range of transmission of the transmitter due to the phase difference between the orthogonal frequency signals based on the approximate location; and
d2) removing ambiguity of the angle of the transmitter due to the phase difference between common frequency signals based on the approximate location.

20. The method as recited in claim 12, wherein the steps d) includes the steps of:
d3) removing ambiguity of the range of transmission of the transmitter due to phase difference between orthogonal frequency signals based on the AoA information according to the time difference of arrival (TDoA); and
d4) removing ambiguity of the angle of the transmitter due to phase difference between common frequency signals based on the approximate location.
